(19) United States
(12) Patent Application Publication
(10) Pub. No.: US 2019/0302377 A1
(43) Pub. Date: Oct. 3, 2019

(54) LENS MODULE AND OPTICAL COMMUNICATION MODULE

(71) Applicant: SUMITOMO ELECTRIC INDUSTRIES, LTD., Osaka (JP)

(72) Inventor: Takashi YAMADA, Osaka (JP)

(73) Assignee: SUMITOMO ELECTRIC INDUSTRIES, LTD., Osaka (JP)

(21) Appl. No.: 16/363,029

(22) Filed: Mar. 25, 2019

(30) Foreign Application Priority Data
Mar. 28, 2018 (JP) 2018-062754

(51) Int. Cl. G02B 6/42

(52) U.S. Cl. CPC G02B 6/423; G02B 6/4214; G02B 6/4206

(57) ABSTRACT

A lens module for optically coupling an optical element with an optical fiber is disclosed. The lens module comprises a collimator lens surface, an emitting surface, a reflecting surface, and a support. The collimator lens surface converts incident light into collimated light. The emitting surface emits the collimated light. The reflecting surface which reflects the collimated light toward the emitting surface is positioned on an optical path between the collimator lens surface and the emitting surface. The support supports the optical fiber such that an end surface of the optical fiber faces the emitting surface.

### CROSS-REFERENCE

This application is based on and claims benefits of priority to Japanese Patent Application No. 2018-062754 filed on Mar. 28, 2018, which is incorporated herein by reference in its entirety.

### TECHNICAL FIELD

The present disclosure relates to a lens module and an optical communication module.

### BACKGROUND

US 2013/0259423A1 discloses a lens module for optically coupling an optical element having an optical axis in the vertical direction with an optical fiber having an optical axis in the horizontal direction. The lens module comprises a lens surface facing the optical element, an end wall facing an end surface of the optical fiber, and an inclined wall optically coupling the lens surface with the end wall. The lens surface condenses light emitted from the optical element within the optical fiber through the inclined wall and the end wall. A focal position of the lens is set, in the optical fiber, at a position away from the end surface of the optical fiber by a predetermined distance.

### SUMMARY

The disclosure provides a lens module for optically couples the optical element with the optical fiber. The lens module comprises a collimator lens surface, an emitting surface, a reflecting surface, and a support. The collimator lens surface is configured to convert incident light into collimated light. The emitting surface emits the collimated light. The reflecting surface which is configured to reflect the collimated light toward the emitting surface, is positioned on an optical path between the collimator lens surface and the emitting surface. The support supports the optical fiber such that an end surface of the optical fiber faces the emitting surface.

The disclosure further provides an optical communication module. The optical communication module comprises the above lens module, the optical element, and the optical fiber. The optical element faces the collimator lens surface. The optical fiber is supported by the support such that the end surface of the optical fiber faces the emitting surface.

### BRIEF DESCRIPTION OF THE DRAWINGS

The foregoing and other purposes, aspects and advantages will be better understood from the following detailed description of a preferred embodiment of the disclosure with reference to the drawings, in which:

FIG. 1 is a side view of an optical communication module having a lens module according to an embodiment;

FIG. 2 is a cross-sectional view of the communication module along the II-II line shown in FIG. 1;

FIGS. 3A, 3B and 3C are schematic configuration views of the optical communication modules each having the lens module of each example;

FIGS. 4A, 4B and 4C show graphs representing results of simulation in each of the optical communication modules shown in FIGS. 3A, 3B and 3C;

FIG. 5 is a schematic configuration view of an optical communication module having a lens module of a comparative example; and

FIG. 6 shows a graph representing results of simulation in the optical communication module shown in FIG. 5.

### DETAILED DESCRIPTION

[Technical Problem Solved by Disclosure]

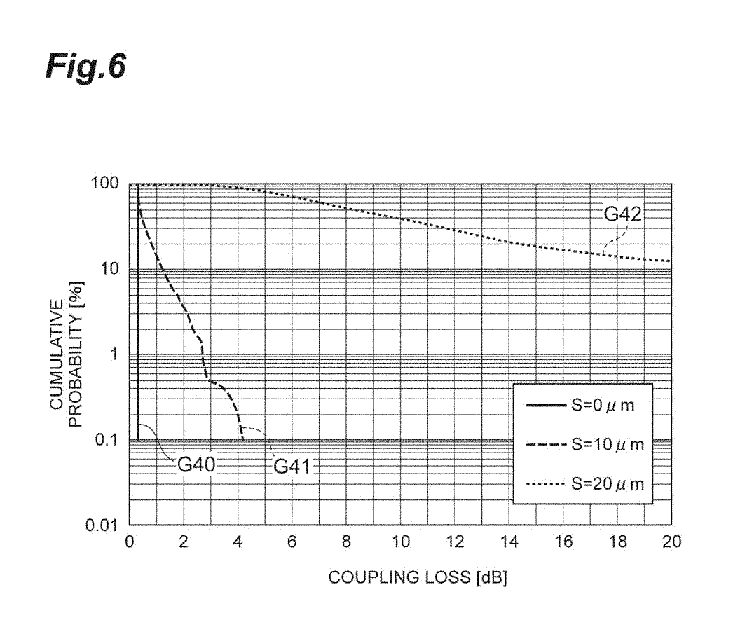

In the lens module of US 2013/0259423A1, a focal point of light from the optical element is set by the lens surface to be positioned in the vicinity of the end surface of the optical fiber in order to obtain high coupling efficiency. However, this setting may change the optical coupling efficiency between the optical element and the optical fiber extremely in some cases (refer to FIG. 6), depending on a deviation amount of a fiber axis with respect to the optical axis of the emitted light from the lens module. Therefore, the above-described configuration sometimes varies the optical coupling efficiency between the optical element and the optical fiber widely in each product.

[Advantageous Effects of Disclosure]

According to a lens module and an optical communication module of the disclosure, it is possible to suppress variations in optical coupling efficiency between an optical element and an optical fiber.

[Description of Embodiment of Disclosure]

Embodiments according to the present disclosure will be listed and described. A lens module according to one embodiment of the present disclosure optically couples an optical element with an optical fiber. The lens module comprises a collimator lens surface, an emitting surface, a reflecting surface, and a support. The collimator lens surface is configured to convert incident light into collimated light. The emitting surface emits the collimated light. The reflecting surface which is configured to reflect the collimated light toward the emitting surface, is positioned on an optical path between the collimator lens surface and the emitting surface. The support supports the optical fiber such that an end surface of the optical fiber faces the emitting surface.

In the above-described lens module, light incident on the collimator lens surface is converted into collimated light by the collimator lens surface, and thereafter, emitted as the collimated light from the emitting surface via the reflecting surface. The collimated light emitted from the emitting surface enters the end surface of the optical fiber facing the emitting surface. In this manner, in the above-described lens module, since the incident light is converted into the collimated light, as compared to a configuration condensing the incident light incident on the optical fiber (that is, a condensing type), it is possible to set a beam diameter of light incident on the end surface of the optical fiber relatively large even when an amount of optical axis deviation of the optical fiber with respect to the optical axis of the emitted light (that is, fiber axis deviation) is increased. Consequently, it is possible to reduce a variation ratio of the amount of light incident on a core of the optical fiber. As a result, according to the embodiment, it is possible to suppress extreme variation in the optical coupling efficiency between the optical element and the optical fiber in each product, to thereby suppress variation in the optical coupling efficiency between the optical element and the optical fiber. Since the lens module of the embodiment uses the collimated light, the amount of light incident on the optical fiber may reduce as compared to the condensing type when there is no fiber axis deviation. However the lens module of the embodiment can suppress the variation ration in the amount of light due to axis deviation of the optical fiber in each product, and therefore this embodiment can provide a structure having strength against the fiber axis deviation. The structure like this can also provide an optical module having stable transmission characteristics without much dependence on mounting accuracy of the optical fiber.

In a transmission system mounting a lens module with high coupling efficiency, such as the condensing type, on an optical fiber, when each component has high mounting accuracy, substantially all the power of emitted light from a light source at one end reaches a light receiver at the other end, and, in some cases, the amount of current generated in the light receiver exceeds an upper limit of a control IC of a transimpedance amplifier (TIA). In other words, so-called TIA overload is sometimes caused, and thereby the IC goes out of control (that is, transmission disabled). However, the lens module of the above-described embodiment uses the collimated light; therefore, it is possible to adjust the amount of light in such a way that a part of the collimated light is not incident on the core of the optical fiber. Consequently, it is possible to suppress excessive increase in the amount of the emitted light incident on the core of the optical fiber. As a result, the embodiment can suppress occurrence of the TIA overload on the receiver at the transmitter.

In the above-described lens module, as one embodiment, the support may include a V-shaped groove extending in a direction intersecting the emitting surface. Consequently, it is possible to achieve positioning of the optical axis of the optical fiber with respect to the lens module with a simple configuration.

In the above-described lens module, as one embodiment, the reflecting surface may be inclined to the emitting surface. As another embodiment, the above-described lens module may further comprise a recess provided between the emitting surface and the support.

An optical communication module according to one embodiment of the present disclosure comprises the above lens module, the optical element, and the optical fiber. The optical element faces the collimator lens surface. The optical fiber is supported by the support such that the end surface of the optical fiber faces the emitting surface. The optical element may be a light source. In the optical communication module, light from the light source is converted into collimated light by the collimator lens surface, and thereafter, emitted as the collimated light from the emitting surface via the reflecting surface. The collimated light emitted from the emitting surface enters the end surface of the optical fiber facing the emitting surface. Since the optical communication module comprises the above-described lens module, similar to the above, it is possible to suppress variations in optical coupling efficiency between the light source and the optical fiber in each product, to thereby provide a structure having strength against the axis deviation of the optical fiber. Further, the optical communication module of the embodiment, similar to the above, can suppress occurrence of the TIA overload on the receiver at the transmitter.

In the above-described optical communication module, as one embodiment, the collimator lens surface may be configured to convert the incident light into collimated light having a beam diameter larger than a diameter of a core of the optical fiber. Consequently, it is possible to suppress extreme variation in the optical coupling efficiency between the optical element and the optical fiber in each product more certainly, to thereby suppress variation in the optical coupling efficiency between the optical element and the optical fiber. Further, it becomes possible for the transmitter to suppress occurrence of the TIA overload on the receiver more certainly. As another embodiment, the collimator lens surface may be configured to convert the incident light from the light source into the collimated light having the beam diameter 1.4 times to 3.6 times as large as the diameter of the core.

In the above-described optical communication module, as one embodiment, the optical fiber may include a core, a cladding that surrounds the core, and a coating that coats the cladding, and the coating may be supported by the support. In this case, since the optical fiber can be placed in the lens module without removing the coating of the optical fiber, it is possible to greatly shorten a mounting process, to thereby achieve cost reduction of the optical communication module. The optical fiber with the coating includes portions with coating having uneven thickness in some cases, and therefore, fiber axis deviation sometimes occurs by the uneven thickness. However, since the optical communication module of the embodiment comprises the lens module with the structure having strength against the axis deviation, it is possible to suppress the variation ratio in the amount of light in each product due to the axis deviation of the optical fiber.

In the above-described optical communication module, as one embodiment the support may include a V-shaped groove extending in a direction intersecting the emitting surface, and the coating may contact each of two side surfaces sharing a bottom line of the V-shaped groove. As another embodiment, the collimator lens surface may be convexly curved toward the light source.

[Details of Embodiment of Disclosure]

A lens module and an optical communication module according to embodiments of the present disclosure will be described with reference to drawings. It is intended that the present invention is not limited to these examples, but defined by the appended claims, and all changes within the scope of the claims and their equivalents are included in the present invention. In the following description, in description of the drawings, common components are assigned with the same reference sign, and redundant explanation will be appropriately omitted.

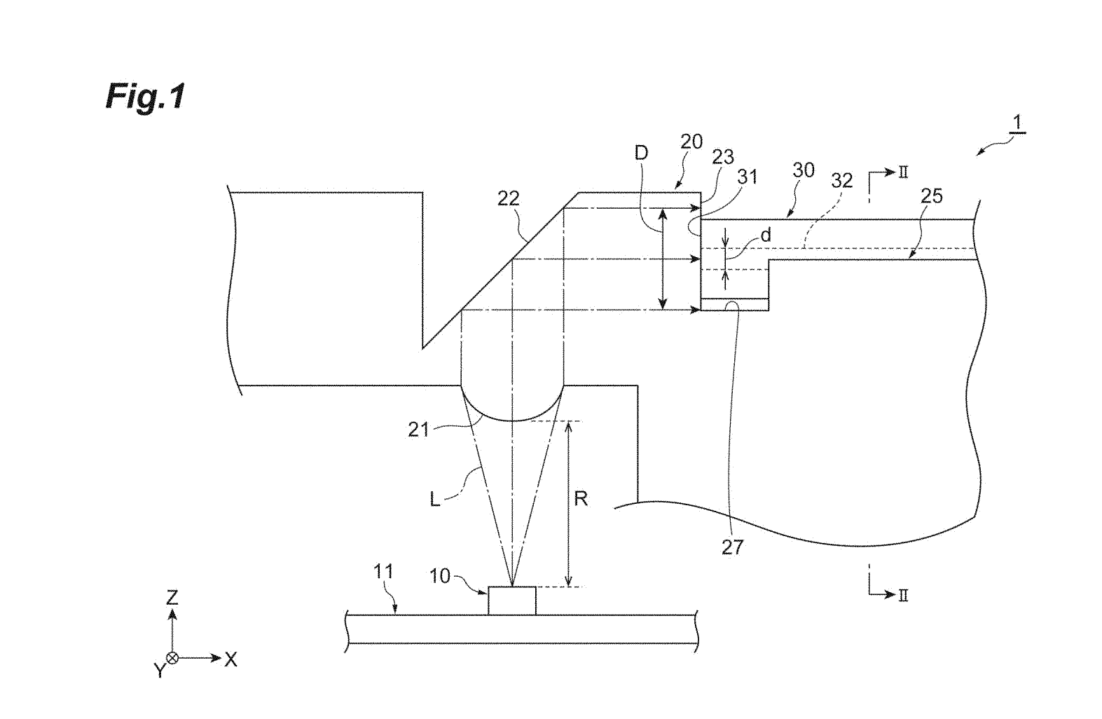

FIG. 1 is a side view of an optical communication module 1 having a lens module 20. In FIG. 1, an XYZ orthogonal coordinate system is shown to facilitate understanding. The optical communication module 1 comprises a light source 10, a lens module 20, and an optical fiber 30. In the optical communication module 1, lens module 20 optically couples the light source 10 with the optical fiber 30. The optical communication module 1 may comprise a light receiving element, such as a photodiode (PD), and the light receiving element may be disposed, for example, to be adjacent to the light source 10, which is a light emitting element, along the Y-axis direction. In this case, similar to the light source 10, the lens module 20 optically couples the light receiving element with another optical fiber 30.

The light source 10 is a light emitting element to perform optical communication, which is, for example, a vertical cavity surface emitting laser (VCSEL) diode that emits multi-mode laser light. The light source 10 may be a distributed feedback laser diode (DFB-LD) or a Fabry-Perot laser diode (FP-LD). The light source 10 is mounted on a mounting board 11 extending along the XY plane and faces the lens module 20 in the Z-direction. The light source 10 includes an optical axis extending along the Z-direction and emits light L of a predetermined wavelength in the Z-direction. Components, such as a driver IC that drives the light source 10, may be mounted on the mounting board 11.

The lens module 20 is a component optically coupling the light source 10 with the optical fiber 30. The lens module 20 is configured with a material (for example, glass) transparent to the wavelength of the light L emitted from the light source 10. The lens module 20 includes a collimator lens surface 21, a reflecting surface 22 and an emitting surface 23. The collimator lens surface 21 faces the light source 10 in the Z-direction and is convexly curved toward the light source 10 in the Z-direction. The collimator lens surface 21 includes an optical axis extending in the Z-direction and is optically coupled with the light source 10. In an example, the optical axis of the collimator lens surface 21 coincides with an optical axis of the light source 10. The light L emitted from the light source 10 enters the collimator lens surface 21.

The collimator lens surface 21 is configured to convert the incident light L into collimated light, that is, parallel light. In such a way that the light L incident on the collimator lens surface 21 is converted into the collimated light, various types of parameters of the collimator lens surface 21 (for example, a surface shape, size or material of the collimator lens surface 21) are optimized in response to a distance R between the collimator lens surface 21 and the light source 10 in the Z-direction. The various types of parameters of the collimator lens surface 21 are derived with ease by using, for example, a commercially available simulator for optical design.

As a result of optimizing the various types of parameters of the collimator lens surface 21, a beam diameter D of the light L converted into the collimated light by the collimator lens surface 21 changes depending on the distance R. Therefore, by adjusting the distance R, it becomes possible to adjust the beam diameter D of the light L. The beam diameter D of the light L is defined by, for example, full width at half maximum (FWHM).

In the collimator lens surface 21, the beam diameter D of the light L is set to be larger than a diameter d of the core 32 of the optical fiber 30. The beam diameter D of the light L is, for example, 1.4 times to 3.6 times as large as the diameter d of the core 32, and preferably, for example, 1.8 times to 2.2 times as large as the diameter d. When the diameter d of the core 32 is 50 μm, the beam diameter D of the light L is, for example, 70 μm to 180 μm, and preferably, for example, 90 μm to 110 μm.

The reflecting surface 22 faces the collimator lens surface 21 in the Z-direction and is inclined to each of the XY plane and the YZ plane. The reflecting surface 22 receives the light L entered from the collimator lens surface 21 and travels in the Z-direction, and reflects all the light L toward the emitting surface 23. An incident optical axis and a reflecting optical axis of the light L on the reflecting surface 22 forms, for example, a right angle. The emitting surface 23 extends along the YZ plane intersecting the X-direction and faces the reflecting surface 22 to be optically coupled therewith in the X-direction. The emitting surface 23 emits the light L reflected by the reflecting surface 22 to the outside.

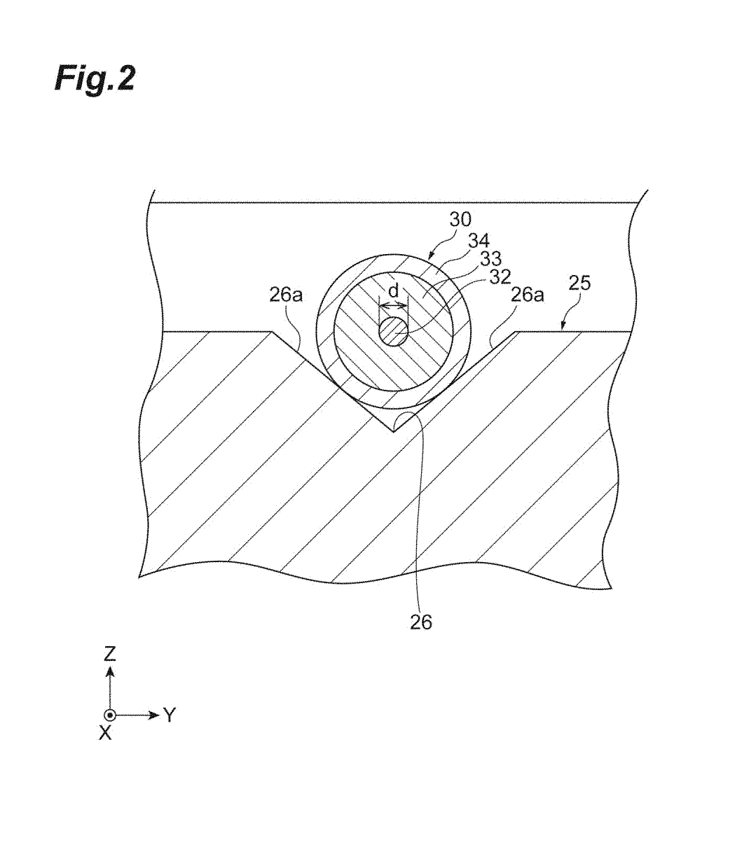

The lens module 20 further includes a support 25 that supports the optical fiber 30. The support 25 is provided on an opposite side of the reflecting surface 22 with respect to the emitting surface 23 in the X-direction. FIG. 2 is a cross-sectional view of the optical communication module 1 shown in FIG. 1 along the II-II line. As shown in FIG. 2, the support 25 includes a V-shaped groove 26 (that is, a groove forming a V shape on the YZ plane) in which the optical fiber 30 is placed. The V-shaped groove 26 extends along the X-direction and defines the position of the optical fiber 30 on the YZ plane. The V-shaped groove 26 is designed in such a way that a bottom line of the V-shaped groove 26 is at the same position as the optical axis of the optical fiber 30 as viewed from the Z-direction. A recess 27 may be formed between the emitting surface 23 and the support 25.

The optical fiber 30 is, for example, a multi-mode optical fiber. The optical fiber 30 may be a single-core optical fiber, a multi-core optical fiber or a single-mode optical fiber. The optical fiber 30 includes the optical axis extending in the X-direction and is placed in the V-shaped groove 26 of the support 25. The optical fiber 30 includes, as shown in FIG. 1, an end surface 31 facing the emitting surface 23 to be optically coupled therewith in the X-direction, and a core 32 extending along the X-direction from the end surface 31. In an example, the end surface 31 contacts with the emitting surface 23 in the X-direction. The light L emitted from the emitting surface 23 enters the end surface 31. The optical axis of the optical fiber 30 is disposed, for example, on the optical axis of the light L emitted from the emitting surface 23.

The optical fiber 30 further includes, as shown in FIG. 2, a cladding 33 that surrounds the core 32 and a coating 34 that coats the cladding 33. In an example, the diameter d of the core 32 is 50 μm, the diameter of the cladding 33 is 125 μm and the diameter of the coating 34 is 250 μm. The coating 34 is provided to protect the core 32 and the cladding 33, and is configured with a resin material. The coating 34 contacts each of two side surfaces 26a sharing the bottom line of the V-shaped groove 26 to be supported. On the optical fiber 30 placed in the V-shaped groove 26, for example, a glass plate is placed. The V-shaped groove 26, the optical fiber 30 and the glass plate are fixed to one another by an adhesive, such as, for example, a UV curable adhesive.

The optical fiber 30 guides the light L entered the core 32 from the end surface 31 and emits thereof to the outside (refer to FIG. 1). The light L emitted to the outside of the optical fiber 30 is received by the light receiver optically coupled with the optical fiber 30. The light receiver includes, for example, a lens condensing the light L emitted from the optical fiber 30, a light receiving element converting the light L condensed by the lens into an electric signal (for example, a photodiode), and an amplifier for amplifying strength of the electric signal (for example, trans impedance amplifier (TIA)). When the optical communication module 1 includes a configuration further comprising the above-described light receiver, the lens module 20 may be disposed on the light receiver.

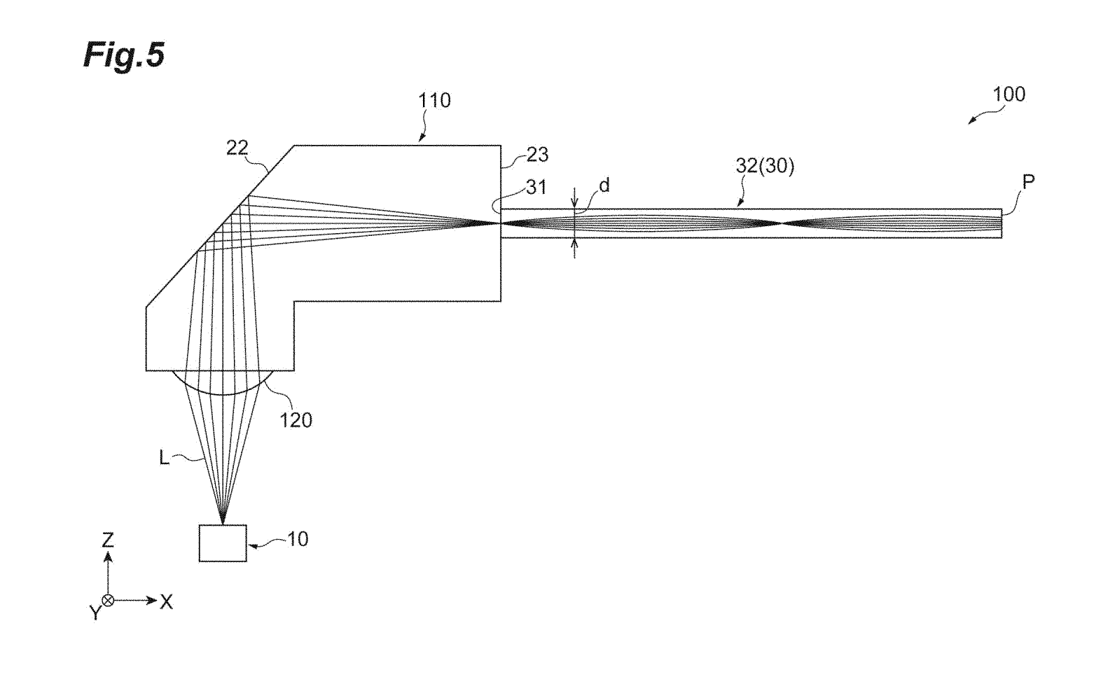

Next, an advantageous effect generated by the optical communication module 1 having the lens module 20 will be described together with a problem that a comparative example involves. FIG. 5 is a schematic configuration view of an optical communication module 100 having a lens module 110 according to a comparative example. In FIG. 5, the cladding 33 and the coating 34 of the optical fiber 30 are omitted to facilitate description. A difference between the optical communication module 100 of the comparative example and the optical communication module 1 of the embodiment is the configuration of the lens module. The lens module 20 of the optical communication module 1 of the embodiment includes the collimator lens surface 21 that converts the light L emitted from the light source 10 into the collimated light, whereas, the lens module 110 of the optical communication module 100 of the comparative example includes, as shown in FIG. 5, instead of the collimator lens surface 21, a condenser lens surface 120 that condenses the light L emitted from the light source 10 on the end surface 31 of the optical fiber 30.

In the optical communication module 100 including the condenser lens surface 120, when axis deviation of the optical fiber 30 occurs, there is a tendency that the core 32 of the optical fiber 30 is likely to deviate from the optical path of the light L. In particular, when the optical fiber 30 including the coating 34 (refer to FIG. 2) is used, the axis deviation of the optical fiber 30 is likely to be increased due to effects of uneven thickness in the coating 34, and thus, a possibility that the core 32 of the optical fiber 30 is deviated from the optical path of the light L is increased. When the core 32 is deviated from the optical path of the light L, the amount of light L incident on the core 32 is extremely reduced; therefore, there is a possibility that the coupling efficiency between the light source 10 and the optical fiber 30 is extremely deteriorated.

The optical communication module 100 is configured to obtain high coupling efficiency between the light source 10 and the optical fiber 30 by taking into consideration mounting errors and the like in each component of the optical communication module 100. Therefore, if each component of the optical communication module 100 is mounted with extremely high accuracy, coupling loss rarely occurs while the light L emitted from the light source 10 reaches the light receiver via the optical fiber 30 in some cases (for example, a case in which only Fresnel loss occurs). In such a case, the amount of light L incident on the light receiving element of the light receiver from the optical fiber 30 is more than that predicted, and there is a possibility that the strength of the electric signal of the light L inputted to an amplifier in the light receiver exceeds an upper limit value of a standard for overload of an amplifier. If the electric signal exceeds the upper limit value of the standard for overload of an amplifier, there is a possibility that the overload of an amplifier occurs, and the amplifier becomes uncontrollable. For example, since an upper limit value of a standard for overload of TIA is small, when light of an amount of a certain level (for example, 2 mW to 3 mW) or more enters the light receiving element, there is a possibility that the overload of TIA occurs.

On the other hand, in the optical communication module 1 having the lens module 20, as shown in FIG. 1, the light L is converted into the collimated light by the collimator lens surface 21. Thus, it is possible to set the beam diameter D of the light L from the emitting surface 23 larger than the diameter d of the core 32 of the optical fiber 30. Consequently, even when the deviation amount of the optical axis of the optical fiber 30 with respect to the optical axis of the light L is increased, it is possible to make the core 32 less easily deviated from the optical path of the light L, and to suppress extreme variation in the amount of light L incident on the core 32. As a result, it is possible to suppress extreme variation in the optical coupling efficiency between the light source 10 and the optical fiber 30 in each product, to thereby suppress variation in the optical coupling efficiency between the light source 10 and the optical fiber 30. Since the configuration of the optical communication module 1 uses the collimated light, though the beam diameter D of the light L is not larger than the diameter d of the core 32 of the optical fiber 30, it is possible to suppress variations in the optical coupling efficiency between the light source 10 and the optical fiber 30 to a certain extent, as compared to conventional optical coupling of a condensing type.

In the optical communication module 1, the beam diameter D of the light L is set larger than the diameter d of the core 32, and thereby it is possible to suppress excessive increase in the amount of light L entering the core 32. Consequently, for example, it is possible, at the transmitter, to restrain a strong signal of the light L exceeding the upper limit value of the standard for overload from being inputted to the light receiver (for example, the amplifier) optically coupled with the optical fiber 30. Further, by adjusting the size of the beam diameter D of the light L with respect to the diameter d of the core 32 of the optical fiber 30, the amount of light L entering the core 32 can be adjusted, and thereby the magnitude of the coupling loss between the light source 10 and the optical fiber 30 can be adjusted. When an upper limit value of an acceptable range of the coupling loss between the light source 10 and the optical fiber 30 is set based on a transmission speed of the light L in the optical communication module 1, by adjusting the coupling loss between the light source 10 and the optical fiber 30 in response to the transmission speed of the light L, it is possible to keep the coupling loss within the acceptable range. Consequently, the optical communication module 1 capable of coping with various kinds of transmission speed (for example, a higher transmission speed) can be realized.

The support 25 includes the V-shaped groove 26 extending in the X-direction perpendicular to (or intersecting) the emitting surface 23. Consequently, it is possible to achieve positioning of the optical axis of the optical fiber 30 with respect to the lens module 20 with a simple configuration.

The collimator lens surface 21 is configured to convert the incident light L into the collimated light having the beam diameter D larger than the diameter of the core 32 optical fiber 30. Consequently, it is possible to suitably obtain the above-described advantageous effect.

The optical fiber 30 includes the coating 34 that coats the cladding 33 surrounding the core 32, and the coating 34 is supported by the support 25. Since the optical fiber 30 can be placed in the lens module 20 without removing the coating 34 of the optical fiber 30 in this case, it is possible to greatly shorten the mounting process, to thereby achieve cost reduction of the optical communication module 1. The optical fiber 30 including the coating 34 sometimes has portions in which the coating with uneven thickness and the fiber axis deviation by the uneven thickness occurs in some cases. However, since the optical communication module 1 comprises the lens module 20 with the structure having strength against the axis deviation, it is possible to suppress the variation ratio in the amount of light in each product due to the axis deviation of the optical fiber 30.

### EXAMPLES

Hereinafter, the present disclosure will be described more specifically based on examples and a comparative example; however, the present invention is not limited to the following examples.

First, in each of optical communication modules according to the comparative example and Examples 1 to 3, correlation between the amount of axis deviation of the optical fiber 30 and the coupling loss of the light source 10 and the optical fiber 30 was examined by use of an optical simulator (for example, Zemax).

As an optical communication module of the comparative example, the optical communication module 100 with the configuration shown in FIG. 5 was adopted. The optical communication module 100 condenses the light L from the light source 10 by the lens module 110 including the condenser lens surface 120, to thereby condense the light L on the end surface 31 of the optical fiber 30.

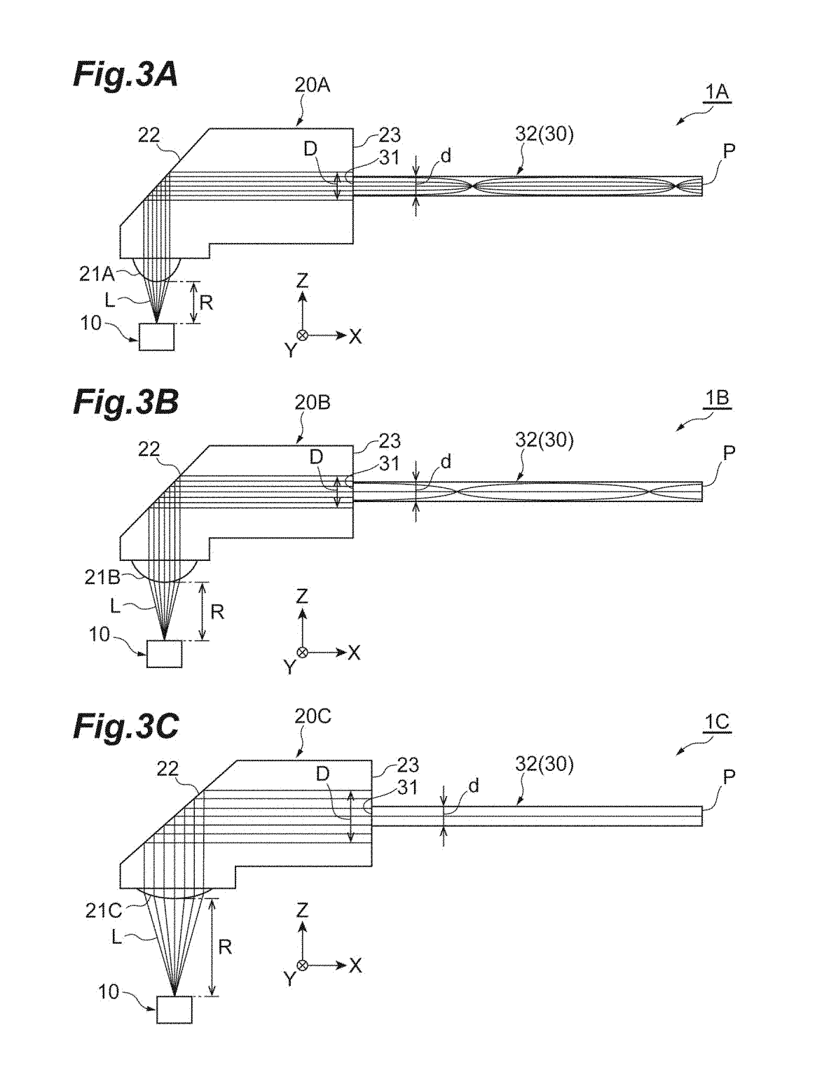

On the other hand, as an optical communication module of the examples, the optical communication module 1 with the configuration shown in FIG. 1 is adopted; more specifically, Examples 1 to 3 adapted optical communication modules 1A to 1C including the collimator lens surfaces having beam diameters D shown in FIGS. 3A to 3C, respectively. FIG. 3A is a schematic configuration view of the optical communication module 1A according to Example 1. FIG. 3B is a schematic configuration view of the optical communication module 1B according to Example 2. FIG. 3C is a schematic configuration view of the optical communication module 1C according to Example 3. To facilitate description, in each figure, the cladding 33 and the coating 34 of the optical fiber 30 are omitted. As shown in FIGS. 3A to 3C, the respective optical communication modules 1A to 1C comprise the same configuration as the above-described embodiment. However, the respective optical communication modules 1A to 1C are configured to have collimator lens surfaces 21A to 21C, respectively, with the shapes different from one another depending on the distances R with the light source 10.

In Example 1, as shown in FIG. 3A, the distance R between the light source 10 and the collimator lens surface 21A in the Z direction was set at 100 μm. The shape of the collimator lens surface 21A was optimized to convert the light L into the collimated light when the distance R was 100 μm, and the beam diameter D of the light L corresponding to the distance R was 75 μm.

In Example 2, as shown in FIG. 3B, the distance R between the light source 10 and the collimator lens surface 21B in the Z direction was set at 170 μm. The shape of the collimator lens surface 21B was optimized to convert the light L into the collimated light when the distance R was 170 and the beam diameter D of the light L corresponding to the distance R was 100 μm.

In Example 3, as shown in FIG. 3C, the distance R between the light source 10 and the collimator lens surface 21C in the Z direction was set at 300 μm. The shape of the collimator lens surface 21C was optimized to convert the light L into the collimated light when the distance R was 300 μm, and the beam diameter D of the light L corresponding to the distance R was 160 μm.

In the simulator examination, in each of the comparative example and Examples 1 to 3, the coupling loss between the light source 10 and the optical fiber 30 and a cumulative probability of the coupling loss, when the amount of axis deviation of the optical fiber 30 varied to 0 μm, 10 μm and 20 μm, were calculated by simulation. The amount of axis deviation of the optical fiber 30 is a distance between the optical axis of the light L from the light source 10 and the optical axis of the optical fiber 30 on the YZ plane.

The cumulative probability of the coupling loss is calculated by taking into account a tolerance of thickness of the light source 10 in the Z direction, mounting accuracy between the light source 10 and the lens module, and mounting accuracy between the lens module and the optical fiber 30. In this simulation, the tolerance in thickness of the light source 10 in the Z direction was set at ±10 μm, mounting accuracy of the light source 10 on the mounting board was set at ±5 μm, and lens manufacturing accuracy of the collimator lens surface and the condenser lens surface was set at ±4 μm. As the light source 10, a multi-mode VCSEL with a wavelength of 850 nm was assumed, and the beam spread angle thereof was set at 32°. The diameter d of the core 32 of the optical fiber 30 was set at 50 μm and the length of the core 32 was set at 1 mm. The coupling loss is a coupling loss at the other end of 1 mm of the core 32 in this simulation.

FIG. 6 shows graphs representing results of the simulation in the optical communication module 100 according to the comparative example. In FIG. 6, the horizontal axis represents the coupling loss between the light source 10 and the optical fiber 30, and the vertical axis represents the cumulative probability of the coupling loss by logarithmic representation. In FIG. 6, the graph G40 shows a case in which an axis deviation amount S of the optical fiber 30 is 0 μm, the graph G41 shows a case in which an axis deviation amount S of the optical fiber 30 is 10 μm, and the graph G42 shows a case in which an axis deviation amount S of the optical fiber 30 is 20 μm. The reason of setting the axis deviation amount S of the optical fiber 30 at 20 μm is that a case in which the axis deviation amount S of the optical fiber 30 including the coating 34 becomes the maximum is assumed.

As shown in FIG. 6, it is shown that, when the axis deviation amount S of the optical fiber 30 is small, such as 0 μm, the coupling loss between the light source 10 and the optical fiber 30 is small, whereas, when the axis deviation amount S of the optical fiber 30 is large, such as 10 μm or 20 μm, the coupling loss between the light source 10 and the optical fiber 30 is extremely increased. In particular, when the axis deviation amount S of the optical fiber 30 is 20 μm, the coupling loss between the light source 10 and the optical fiber 30 is extremely large. As described above, in the optical communication module 100 according to the comparative example, when the axis deviation amount S of the optical fiber 30 was increased, the coupling loss between the light source 10 and the optical fiber 30 was extremely varied. Consequently, in the optical communication module 100 of the comparative example, there is a possibility that the optical coupling efficiency between the light source 10 and the optical fiber 30 varies widely in each product.

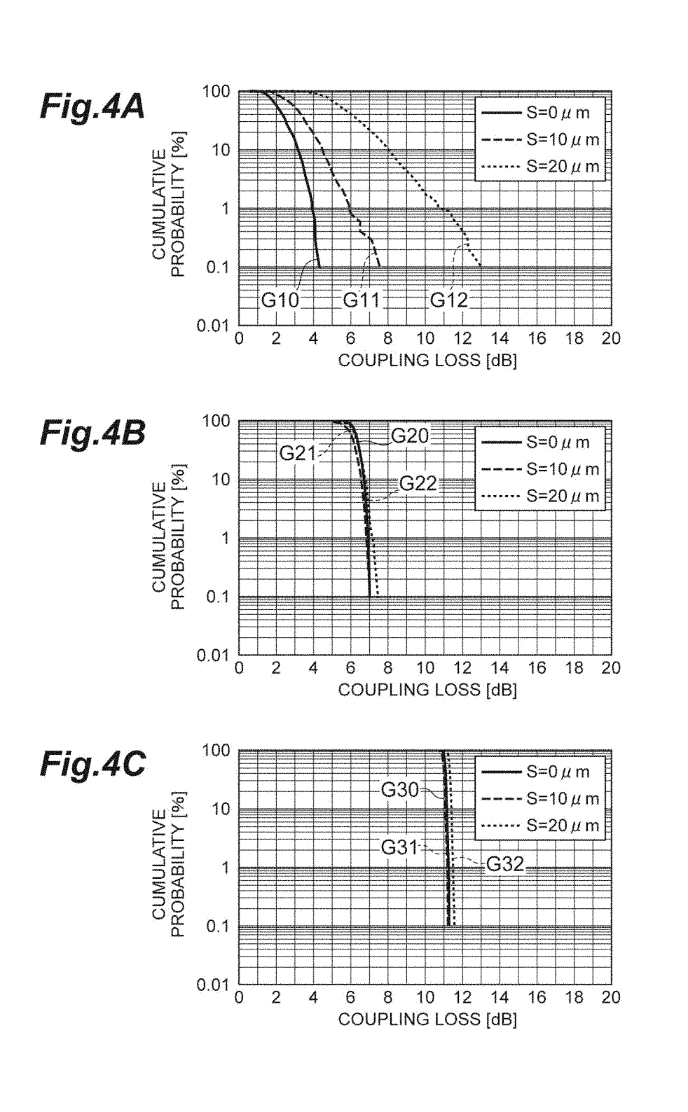

FIG. 4A shows graphs representing results of the simulation in the optical communication module 1A according to Example 1. In FIG. 4A, the graph G10 shows a case in which an axis deviation amount S of the optical fiber 30 is 0 μm, the graph G11 shows a case in which an axis deviation amount S of the optical fiber 30 is 10 μm, and the graph G12 shows a case in which an axis deviation amount S of the optical fiber 30 is 20 μm.

FIG. 4B shows graphs representing results of the simulation in the optical communication module 1B according to Example 2. In FIG. 4B, the graph G20 shows a case in which an axis deviation amount S of the optical fiber 30 is 0 μm, the graph G21 shows a case in which an axis deviation amount S of the optical fiber 30 is 10 μm, and the graph G22 shows a case in which an axis deviation amount S of the optical fiber 30 is 20 μm.

FIG. 4C shows graphs representing results of the simulation in the optical communication module 1C according to Example 3. In FIG. 4C, the graph G30 shows a case in which an axis deviation amount S of the optical fiber 30 is 0 μm, the graph G31 shows a case in which an axis deviation amount S of the optical fiber 30 is 10 μm, and the graph G32 shows a case in which an axis deviation amount S of the optical fiber 30 is 20 μm.

In each of FIGS. 4A to 4C, similar to FIG. 6, the horizontal axis represents the coupling loss between the light source 10 and the optical fiber 30, and the vertical axis represents the cumulative probability of the coupling loss by logarithmic representation. As shown in each of FIGS. 4A to 4C, in Examples 1 to 3, even when the axis deviation amount S of the optical fiber 30 is large, as compared to the comparative example (refer to FIG. 6), the coupling loss between the light source 10 and the optical fiber 30 does not vary extremely. In other words, in each of Examples 1 to 3, as compared to the comparative example, the variation amount of the coupling loss between the light source 10 and the optical fiber 30 due to the effect of axis deviation in the optical fiber 30 is small.

Further, as shown in each of FIGS. 4A to 4C, the variation amount of the coupling loss due to the effect of axis deviation in optical fiber 30 differs in each example. This is considered to be due to the effect of the size of beam diameter D of the light L with respect to the diameter d of the core 32. When the diameter d of the core 32 is 50 μm, taking into account that the maximum amount of the axis deviation amount S of the optical fiber 30 including the coating 34 is around 20 μm, there is a possibility that a center position of the core 32 moves within a range of ±20 μm from a center axis of the optical fiber 30 in the YZ plane. Therefore, it is considered that, if the beam diameter D of the light L is larger than, for example, 90 μm, it is possible to prevent the core 32 from deviating from the optical path of the light L without being affected by the axis deviation of the optical fiber 30. On the other hand, it is considered that, since the amount of light L entering the core 32 is reduced as the beam diameter D of the light L with respect to the diameter d of the core 32 becomes larger, the maximum value of the coupling loss between the light source 10 and the optical fiber 30 is increased.

Here, with reference to FIG. 4B, it is shown that the coupling losses between the light source 10 and the optical fiber 30 are almost constant, irrespective of the axis deviation amounts S of the optical fiber 30. Further, it is shown that the maximum values of the coupling loss are kept small, such as around 7.5 dB. In the optical communication module 1B corresponding to FIG. 4B, since the beam diameter D of the light L is 100 which is larger than 90 μm, it is possible to keep the core 32 within the optical path of the light L while securing a margin of 10 μm. Therefore, it is considered that the variation amount of the coupling loss between the light source 10 and the optical fiber 30 due to the effect of axis deviation in the optical fiber 30 was reduced. Further, it is considered that, since the beam diameter D of the light L was not excessively large with respect to the diameter d of the core 32, it was possible to keep the maximum values of the coupling loss between the light source 10 and the optical fiber 30 small.

With reference to FIG. 4C, it is shown that, similar to FIG. 4B, the coupling losses between the light source 10 and the optical fiber 30 are almost constant, irrespective of the axis deviation amounts S of the optical fiber 30. On the other hand, in FIG. 4C, as compared to FIG. 4B, it is shown that the maximum values of the coupling loss between the light source 10 and the optical fiber 30 are increased on the whole. In the optical communication module 1C corresponding to FIG. 4C, since the beam diameter D of the light L is 160 μm, which is larger than 90 μm, it is possible to keep the core 32 within the optical path of the light L while securing a sufficient margin. In the optical communication module 1C, since the beam diameter D of the light L is relatively large with respect to the diameter d of the core 32, the amount of light L entering the core 32 is reduced, and the maximum values of the coupling loss are increased on the whole.

With reference to FIG. 4A, it is shown that, in the cases in which the axis deviation amounts S of the optical fiber 30 are 0 μm and 10 μm (refer to the graphs G10 and G11), the maximum values of the coupling loss between the light source 10 and the optical fiber 30 are kept small as compared to FIG. 4C. On the other hand, when the axis deviation amount of the optical fiber 30 is increased to 20 μm (refer to the graph G12), the maximum value of the coupling loss between the light source 10 and the optical fiber 30 is large as compared to FIG. 4C.

In the optical communication module 1A corresponding to FIG. 4A, the beam diameter D of the light L is 75 μm, and the size of the beam diameter D is at a level slightly larger than 50 μm, which is the diameter d of the core 32. Therefore, it is considered that, in the cases in which the axis deviation amounts S of the optical fiber 30 were 0 μm and 10 μm (refer to the graphs G10 and G11), it was possible to suppress reduction in the amount of light L with respect to the core 32, and thereby, it was possible to keep the maximum values of the coupling loss between the light source 10 and the optical fiber 30 small. However, since the beam diameter D of the light L is 75 μm, which is smaller than 90 μm, there is a possibility that the core 32 is deviated from the optical path of the light L when the axis deviation amount S of the optical fiber 30 is increased. Therefore, it is considered that, when the axis deviation amount of the optical fiber 30 was as large as 20 μm, the maximum value of the coupling loss between the light source 10 and the optical fiber 30 was slightly large as compared to FIG. 4C.

From the above-described results of the simulation, it was confirmed that, in any of Examples 1 to 3, variations in the coupling loss occurring due to axis deviation of the optical fiber 30 were able to be suppressed as compared to the comparative example. Further, as in Example 2, in the case of the beam diameter D (in this example, 100 μm) optimized taking into account an eccentricity amount of the core 32 due to uneven thickness of the coating 34, it could be confirmed that it was possible to lower the maximum value of the coupling loss, in addition to suppressing variations in the coupling loss. These examples are merely an instance in this simulation, and are able to be appropriately changed in response to characteristics of the optical fiber 30 and characteristics of the light source 10. Further, from the results of the simulation, it was confirmed that the maximum value of the coupling loss between the light source 10 and the optical fiber 30 is varied in response to the size of the beam diameter D. Here, since the size of the beam diameter D is set in response to the distance R between the light source 10 and the collimator lens surfaces 21A to 21C, by adjusting the distance R, it is possible to adjust the coupling loss between the light source 10 and the optical fiber 30. Consequently, it becomes possible to adjust the coupling loss to a desired value.

Subsequently, for each of the optical communication module 1B according to Example 2 (refer to FIG. 3B) and the optical communication module 100 according to the comparative example (refer to FIG. 5), transmission characteristics evaluation at 20 Gbps was performed.

First, as the comparative example, the optical communication module 100 with the configuration shown in FIG. 5 was manufactured as a module on the transmitter in optical communication. The lens module 110 of the optical communication module 100 included, as described above, the condenser lens surface 120 configured to condense the light L emitted from the light source 10 on the end surface 31 of the optical fiber 30. As the light source 10 of the optical communication module 100, the VCSEL that emits multi-mode laser light with the wavelength of 850 nm was used, and the driver IC was mounted on the circuit board on which the light source 10 was mounted. Further, in the optical communication module 100, the optical fiber 30 was placed in the V-shaped groove designed for supporting an optical fiber to be mounted. The V-shaped groove 26 (refer to FIG. 2) was configured in such a way that, when the optical fiber 30 with a predetermined outer diameter was mounted, the center thereof coincided with the optical axis of the lens system. Then, after placing the optical fiber 30 in the V-shaped groove 26, while pressing the optical fiber 30 by a glass plate from above, the optical fiber 30 was fixed to the support 25 including the V-shaped groove 26 by use of a UV curable adhesive. Further, as the receiver, an optical system condensing the light L emitted from an end surface on the opposite side of the optical fiber 30 by the lens and receiving the light by the photodiode (PD) was adopted.

As Example 2, the optical communication module 1B with the configuration shown in FIGS. 1 and 3B was manufactured as a module on the transmitter in optical communication. The lens module 20B of the optical communication module 1B included, as described above, the collimator lens surface 21B configured to convert the light L emitted from the light source 10 into collimated light, and to cause the collimated light to enter the end surface 31 of the optical fiber 30. As the light source 10 of the optical communication module 1B, similar to the comparative example, the VCSEL that emits multi-mode laser light with the wavelength of 850 nm was used, and the driver IC was mounted on the circuit board on which the light source 10 was mounted. Further, in the optical communication module 1B, the optical fiber 30 was placed in the V-shaped groove 26 designed for supporting an optical fiber 30 to be mounted. The V-shaped groove 26 was configured in such a way that, when the optical fiber 30 with a predetermined outer diameter was mounted, the center thereof coincided with the optical axis of the lens system. Then, after placing the optical fiber 30 in the V-shaped groove 26, while pressing the optical fiber 30 by the glass plate from above, the optical fiber 30 was fixed to the support 25 including the V-shaped groove 26 by use of the UV curable adhesive. Further, as the receiver, similar to the comparative example, an optical system condensing the light L emitted from an end surface on the opposite side of the optical fiber 30 by the lens and receiving the light by the PD was adopted.

In the characteristics evaluation, as the optical fiber 30, two types of optical fibers, namely, a multi-mode optical fiber including the coating 34 (refer to FIG. 2, hereinafter, referred to as “optical fiber with coating”) and a multi-mode optical fiber not including the coating 34 (hereinafter, referred to as “optical fiber without coating”) were prepared, and each was incorporated into the optical communication modules of the comparative example and Example 2. In the optical fiber with coating, the diameter of the core 32 was 50 μm, the diameter of the cladding 33 (refer to FIG. 2) was 125 μm, the diameter of the coating 34 (that is, an outer diameter of the fiber) was 250 μm, and an eccentricity of the core 32 was 2 μm. In the optical fiber with coating, due to the uneven thickness in the coating 34 of the optical fiber 30, there was axis deviation between the center of the lens surface and the center of the core 32, and the deviation amount was 20 μm. On the other hand, in the optical fiber without coating, the diameter of the core 32 was 50 μm, the diameter of the cladding 33 was 125 μm, and the eccentricity of the core 32 was 2 μm. In the optical fiber without coating, the axis deviation amount between the center of the lens surface and the center of the core 32 was 5 μm.

Regarding the optical communication module 100 of the comparative example, when transmission characteristics evaluation was performed for each of the case using the optical fiber with coating and the case using the optical fiber without coating, in any of the cases, error free transmission was not able to be achieved. As a factor of preventing the error free transmission from being achieved as described above, for example, when the optical fiber without coating was used, it is considered that the overload of the amplifier (TIA) occurred because the amount of light L incident on the light receiver from the optical fiber was large; when the optical fiber with coating was used, it is considered that the coupling loss was increased due to axis deviation of the optical fiber.

On the other hand, regarding the optical communication module 1B of Example 2, when transmission characteristics evaluation was performed for each of the case using the optical fiber with coating and the case using the optical fiber without coating, in any of the cases, error free transmission was able to be achieved. From the results, it could be confirmed that, by use of the optical communication module 1B, it was possible to eliminate the above-described factor occurred in the optical communication module 100 of the comparative example, to thereby achieve error-free high speed transmission.

The lens module and the optical communication module according to the present invention are not limited to the above-described embodiment and respective examples, and various other modifications are available. For example, the shape of the lens module is not limited to the above-described embodiment and respective examples, and appropriate modifications are available. In the above-described embodiment and respective examples, the support of the lens module included the V-shaped groove; however, instead of the V-shaped groove, other shapes may be provided. The types and arrangement of the light source and the types and arrangement of the optical fiber are not limited to the above-described embodiment and respective examples, and appropriate modifications are available.

The optical communication module may comprise a plurality of (for example, four) optical fibers aligned along the Y direction and a plurality of (for example, two) light sources and a plurality of (for example, two) light receiving elements aligned along the Y direction. In this case, in the lens module, a plurality of V-shaped grooves may be provided in line along the Y direction respectively corresponding to arrangement of the plurality of optical fibers, and a plurality of collimator lens surfaces may be provided in line along the Y direction respectively corresponding to arrangement of the plurality of optical fibers. The plurality of light sources and the plurality of light receiving elements may be disposed to face the plurality of collimator lenses, respectively, in the Z direction.

What is claimed is:

1. A lens module for optically coupling an optical element with an optical fiber, the lens module comprising:
a collimator lens surface configured to convert incident light into collimated light;
an emitting surface that emits the collimated light;
a reflecting surface configured to reflect the collimated light toward the emitting surface, the reflecting surface being positioned on an optical path between the collimator lens surface and the emitting surface; and
a support configured to support the optical fiber such that an end surface of the optical fiber faces the emitting surface.

2. The lens module according to claim 1, wherein the support includes a V-shaped groove extending in a direction intersecting the emitting surface.

3. The lens module according to claim 1, wherein the reflecting surface is inclined to the emitting surface.

4. The lens module according to claim 1, further comprising a recess provided between the emitting surface and the support.

5. An optical communication module comprising:
the lens module according to claim 1;
the optical element that faces the collimator lens surface; and
the optical fiber supported by the support such that the end surface faces the emitting surface.

6. The optical communication module according to claim 5, wherein the optical element includes a light source.

7. The optical communication module according to claim 6, wherein the collimator lens surface is configured to convert the incident light from the light source into the collimated light having a beam diameter larger than a diameter of a core of the optical fiber.

8. The optical communication module according to claim 6, wherein the collimator lens surface is configured to convert the incident light from the light source into the collimated light having a beam diameter 1.4 times to 3.6 times as large as a diameter of a core of the optical fiber.

9. The optical communication module according to claim 6, wherein the optical fiber includes a core, a cladding that surrounds the core, and a coating that coats the cladding, the coating being supported by the support.

10. The optical communication module according to claim 9, wherein the support includes a V-shaped groove extending in a direction intersecting the emitting surface, and the coating contacts each of two side surfaces sharing a bottom line of the V-shaped groove.

11. The optical communication module according to claim 6, wherein the collimator lens surface is convexly curved toward the light source.
